(19) United States
(12) Patent Application Publication
(10) Pub. No.: US 2023/0316754 A1
(43) Pub. Date: Oct. 5, 2023

(54) SYSTEM AND METHOD FOR CONTENT BASED VIDEO ORGANIZATION, PRIORITIZATION, AND RETRIEVAL

(71) Applicant: BAE Systems Information and Electronic Systems Integration Inc., Nashua, NH (US)

(72) Inventor: Vadas Gintautas, Nashua, NH (US)

(73) Assignee: BAE SYSTEMS INFORMATION AND ELECTRONIC SYSTEMS INTEGRATION INC., Nashua, NH (US)

(21) Appl. No.: 17/709,573

(22) Filed: Mar. 31, 2022

(51) Int. Cl. G06V 20/40; G06V 10/25; G06V 10/26; G06V 20/17; G06F 16/787; G06F 16/75

(52) U.S. Cl. CPC G06V 20/49; G06V 10/25; G06V 10/26; G06V 20/46; G06V 20/17; G06F 16/787; G06F 16/75; G06V 2201/10

(57) ABSTRACT

A content based video organization, prioritization, and retrieval system and method utilizes metadata contained or included with or inferred from image frames of a video stream obtained from a sensor carried by a platform. The metadata are indexed and stored for processing to automatically create workflows depicting resultant images of a target, object, or location of interest. The workflows can be incorporated with a representation or graph based on the metadata that is time agnostic with respect to when the image frame containing the metadata was obtained by the sensor.

### TECHNICAL FIELD

The present disclosure relates to an image system. More particularly, the present disclosure relates to a system used for organization, prioritization, and retrieval of information obtained from a video image sensor. Specifically, the present disclosure relates to a content based video organization, prioritization, and retrieval system that can be used to automatically produce image workflows leveraging image sensor metadata parameters obtained from the image sensor.

### BACKGROUND

Current systems can create workflows from a video stream. In some situations, workflows are created and used by a team of personnel watching a video as the video is being filmed by a platform, such as a drone or a UAV. The team of personnel may review or watch the video later, after the filming is complete; this is referred to as forensic use of the video. A typical workflow will task the team with obtaining multiple views of a location of interest (LOI), and identify an object or target, such as a building. To create the workflow product having multiple views of the building, it is labor intensive inasmuch as the team needs to watch the video and utilize video controls, such as timeline scrolling features, to fast-forward or rewind through the video stream in order to look for the desired target frame by frame until the view is from the desired angle.

Typically, once the video frame is at a desired point in time containing the object or target, a directional marker, such as a coordinate arrow, can be placed into the workflow product to identify directions in a resultant image.

The workflow product is generally used for surveillance, reconnaissance, and intelligence-gathering objectives. These data are then exported to another program, such as PowerPoint, to allow higher-level data to be utilized and evaluated as necessary. The higher-level data can be studied to determine various features, such as the time and LOI at which certain objects that are being surveilled were observed.

The problems associated with this labor intensive and manual process is that it requires an operator to find and tag the LOI in one of the video frames. Once the location is tagged in an image frame, the operator must seek multiple time slices in the video where the LOI is visible and manually evaluate the look angle, perspective, and GSD. The operator then must narrow down the best views, from the different directions (typically four, namely, north, south, east, and west). The operator then fine-tunes each view by using detailed video-seek controls. Once the views are selected, they must be exported and merged into a finishing tool for placement into another software, such as PowerPoint. As can be readily seen, this is laborious and results in a specific computer-implemented problem of significant labor by the operator.

### SUMMARY

To address these computer-specific problems associated with processing video imagery, the present disclosure provides a content based video organization, prioritization, and retrieval system and method that utilizes metadata contained in, included with, or derived from image frames of a video stream obtained from a sensor carried by a platform. The metadata are indexed and stored for processing to automatically create workflows depicting resultant images of a target, object, or location of interest. The workflows can be incorporated with a representation or graph based on the metadata that is time agnostic with respect to when the image frame containing the metadata was obtained by the sensor.

In one aspect, an exemplary embodiment of the present disclosure may obtain video imagery from a platform that is moving relative to the LOI. The system may accumulate multiple objects within the video imagery, wherein one object is at the LOI. The system may aggregate, collect or otherwise index some or all of the image frames containing sensor metadata parameters. These image frames from the video stream may be sequential or non-sequential in the video sequence, regardless of whether there are non-metadata containing image frames intermediate the frames containing the metadata parameters. In one embodiment, the frames containing metadata parameters occur every sixth frame in the video sequence.

This exemplary embodiment or another exemplary embodiment may find the LOI where an action item or further discrimination is needed. For example, the location where a 360° workflow resultant product needs to be created. The system or logic of the system locates the LOI. This may be accomplished by enabling an operator to draw a rotated rectangle or other shape in a frame of the video imagery over or around the LOI, or in an overhead map view containing the LOI but not derived specifically from the video imagery. In some instances, the edges of the rectangle or shape are aligned with the desired view to advance or meet the application specific requirements of the action item or discriminatory requirements. The metadata for this frame may then be indexed.

This exemplary embodiment or another exemplary embodiment may process the indexed data to produce a resultant image or product based on the content based video organization, prioritization, and retrieval. This may include parsing video metadata parameters obtained from the sensor. The parsed metadata can be indexed or tabulated to accomplish location-based bookkeeping of metadata parameters. The system may group image frames containing a specific object at the LOI and then determine which of the grouped images is most desirable or useful based on which parameter is to be prioritized. The system may then filter the video stream based on metadata parameters. The system may then condense the video stream to a shortened video stream containing the LOI and excluding (some or all) of the video frames that do not depict the LOI. Then, the system may bridge together non-sequential video frames that each depict the LOI at different times as a condensed video stream. The system may then enable rapid retrieval of image data based on the metadata parameters.

This exemplary embodiment or another exemplary embodiment may output, automatically, a resultant view (or workflow product) to meet the requirements of the action item (e.g., generate the four cardinal images for a 360° workflow product). Within the resultant view or product, the logic of the system creates a circular cardinal coordinate representation or icon that is shown in conjunction with the resultant view. The cardinal coordinate representation can be manipulated by user input. Manipulation or actuation, via user input, causes the system to create different image views based on image frames from the condensed video stream. The cardinal coordinate representation may have dots or other icons initially representing north, south, east, and west. Further, the cardinal coordinate representation may have a circular ring icon that has thicker portion and thinner portions. The thickness or width of the circle represents or corresponds to image quality. For example, thicker portions of the circle can represent image frames with better resolution or ground spatial distance (GSD) or other parameters. The cardinal coordinate representation enables the user to toggle to views of image frames, wherein those views of image frames originate from any time in the original video stream or feed that are not necessarily sequential. Rather, the different views of a LOI from all angles are sorted by best or optimized parameters. The cardinal coordinate representation also enables the user to drag one point to adjust the perspective by a few degrees or shift drag to adjust all four views in unison. Then, once the optimal resultant product has been generated and approved, this may be exported to another software program, such as PowerPoint, for further review or discrimination.

This exemplary embodiment or another exemplary embodiment may also provide upgrades to workflows via data summarization. If a video depicts the LOI on screen, the system may generate a graph of GSD quality or other parameters along the timeline, and gaps in the timeline when the LOI was not visible. This exemplary embodiment or another exemplary embodiment may also provide upgrades to map based data summarization. The system may generate a heat map in a map view showing the spatial coverage area of where the video was obtained.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view of a system for content based video organization, prioritization, and retrieval according to various aspects of the present disclosure.

FIG. 2 (FIG. 2) is a diagrammatic view of a coverage area containing a plurality of frames containing metadata parameters obtained from a sensor.

FIG. 3 (FIG. 3) is an exemplary grid with a coverage area associated with the image sensor.

FIG. 4A (FIG. 4A) is the exemplary grid and coverage area shown in FIG. 3 with one image frame containing metadata parameters shaded therein.

FIG. 4B (FIG. 4B) is another exemplary grid and coverage area with one image frame registered with map imagery.

FIG. 5 (FIG. 5) is an exemplary grid having corresponding binary pixel values associated with one image frame.

FIG. 6A (FIG. 6A) is an exemplary grid having summed pixel values from a plurality of frames.

FIG. 6B (FIG. 6B) is a schematic view of creating a coarse grained representation of image coverage results.

FIG. 7 (FIG. 7) is a first exemplary heat map generated from the logic of the system of the present disclosure.

FIG. 8 (FIG. 8) is a second exemplary heat map generated from the logic of the system of the present disclosure.

FIG. 9 (FIG. 9) is an exemplary view of a computer application integrated with program functionality to effectuate operation of the method of the present disclosure.

FIG. 10A (FIG. 10A) is a diagrammatic view of a video stream timeline that highlights regions in which a target or location of interest was visible in one image frame having sensor metadata associated therewith.

FIG. 10B (FIG. 10B) is a diagrammatic view of the highlighted regions of FIG. 10A having been extracted by the logic of the system of the present disclosure.

FIG. 10C (FIG. 10C) is a diagrammatic view of the highlighted regions of FIG. 10B having been condensed by the logic of the system of the present disclosure.

FIG. 10D (FIG. 10D) is a diagrammatic view of the highlighted regions of FIG. 10C having been prioritized by identifying regions with the highest GSD or other prioritized parameter by the logic of the system of the present disclosure.

FIG. 10E (FIG. 10E) is a diagrammatic view of the highlighted regions of FIG. 10D having been reorganized around a cardinal coordinate representation by the logic of the system of the present disclosure.

FIG. 11 (FIG. 11) is a schematic view of retrieval functionality by the logic of the system of the present disclosure.

FIG. 12 (FIG. 12) is a view containing four cardinal direction images generated by the logic of the present disclosure.

FIG. 13 (FIG. 13) is an exemplary view of a computer program product according to one aspect of an exemplary embodiment of the present disclosure.

FIG. 14 (FIG. 14) is a flowchart depicts an exemplary method according to one aspect of the present disclosure.

Similar numbers refer to similar parts throughout the drawings.

### DETAILED DESCRIPTION

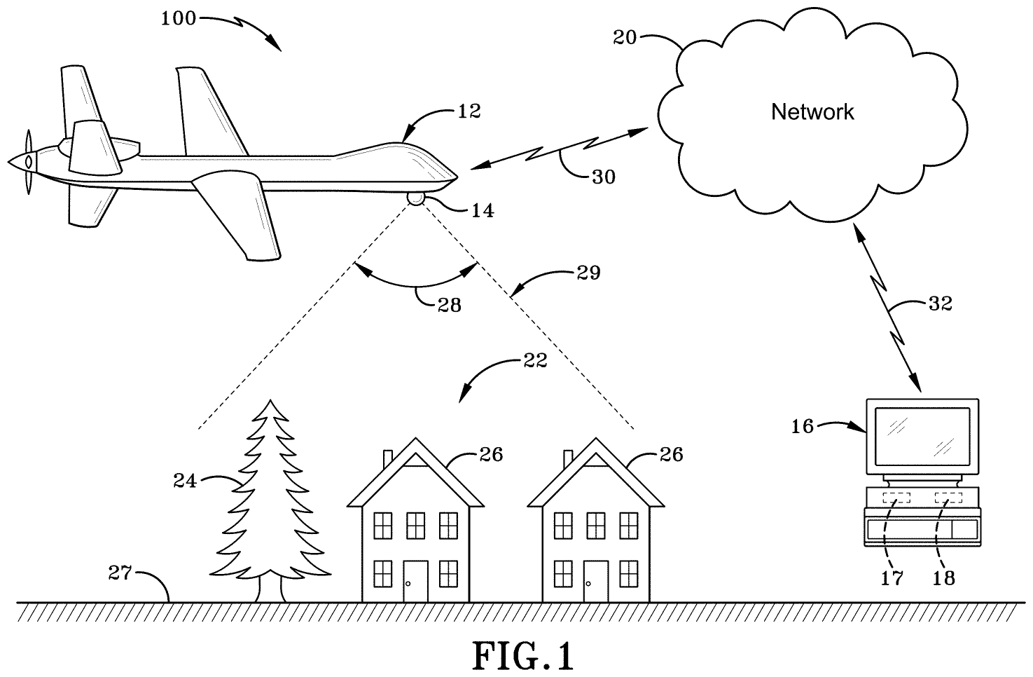

FIG. 1 diagrammatically depicts a content based video organization, prioritization, and retrieval system generally at 100. System 100 may include a platform 12 carrying a camera or video/image sensor 14, a computer 16 operatively coupled to a memory 17 and a processor 18 that form a portion of content based video organization, prioritization, and retrieval logic, a network connection 20, and a geographic landscape 22 which may include natural features 24, such as trees or mountains, or manmade features 26, such as buildings, roads, or bridges, etc., which are viewable from platform 12 through a viewing angle 28 defining a field of view 29 of image sensor 14.

In one particular embodiment, platform 12 is a flying device configured to move above the geographic landscape 22. Platform may be any platform, regardless of whether it is manned or unmanned, such as a drone, an unmanned aerial vehicle (UAV), or satellite as one having ordinary skill in the art would understand. In another example, manned platform refers to planes, jet aircraft, helicopters, zeppelins, balloons, space shuttles, and the like. A further example of platform 12 includes missiles, rockets, guided munitions, and the like. Furthermore, platform 12 could be a fixed location such as one that supports a mast mounted camera, a body camera mount worn on a person, or a fixed closed circuit surveillance camera mount.

Sensor 14 is carried by platform 12 and may be selected from a group of known cameras capable of capturing images in a wide variety of electromagnetic spectrum for image registration. For example, sensor 14 may capture synthetic aperture radar (SAR), infrared (IR), electro-optical (EO), LIDAR, video in any spectrum, and x-ray imagery, amongst many others as one would easily understand. In one example, the sensor 14 is powered from the platform 12 and in another example the sensor 14 has its own power source.

Network 20 allows the transmittal of digital data from sensor 14 to processor 18 and memory 17 in computer 16. Network 20 is preferably an encrypted and secure high-speed internet. When sensor 14 captures a video stream, in any spectrum, composed of sequential image frames, the video stream is sent to network 20 via a first network connection 30. Processor 18 is operatively coupled to network 20 via a second network connection 32.

Further, while computer 16 is depicted as remote from platform 12, in a further embodiment the computer 16 is carried by platform 12 such that the image registration process occurring in memory 17 and processor 18 occurs onboard platform 12 and without employing a network. In this latter embodiment, the image processing would be performed on the platform 12 and the network 20 refers to the internal network within the platform. Alternatively, sensor video streams may be recorded to digital storage media stored on the sensor or platform, and then retrieved after collection and copied digitally to network 20 or computer 16 directly.

As will be described in greater detail below, the system 100 utilizes logic to organize content in frames of the video stream. The logic may prioritize target objects, such as one structure 26, and prioritize it for retrieval and further discrimination. In one particular embodiment, the computer 16 includes a logic configured to robustly register and index SAR, infrared (IR), EO, video, or x-ray imagery. In different examples, the logic may be implemented in hardware, software, firmware, and/or combinations thereof.

Computer 16 operates in the network 20 environment and thus may be connected to other network devices (not shown) via the i/o interfaces, and/or the i/o ports. Through the network 20, the computer 16 may be logically connected to other remote computers. Networks with which the computer may interact include, but are not limited to, a local area network (LAN), a wide area network (WAN), and other networks. The networks may be wired and/or wireless networks.

Memory 17 and processor 18, which are part of the logic of system 100, operate collectively to define a non-transitory computer-readable medium storing a plurality of instructions which, when executed by one or more processors, causes the one or more processors to perform a method for content based video organization, prioritization, and retrieval. The plurality of instructions for the system 100 may include, amongst other things, instructions to obtain a video stream via sensor 14 mounted on platform 12, wherein the video stream includes at least one image frame having metadata parameters, wherein the metadata includes a geospatial reference of the sensor, instructions to locate a location of interest (LOI) shown in at least one frame of the video stream, wherein the LOI includes an object, such as structure 26, that is to be discriminated, instructions to select at least a portion of the frame containing the LOI in the video stream, instructions to process the selected frame containing the portion of the LOI based on the geospatial reference of the sensor in the metadata; and instructions to output, automatically, at least one resultant image in response to the processing, wherein the resultant image includes the object at the LOI to be discriminated. In some instances the LOI is the region around the object. For example, if the object is structure 26, then the LOI would be region in the image frame surrounding the structure 26. As shown in the Figures, the structure 26 includes a driveway, a front yard, a back yard, and some streets that would be part of the LOI.

Having thus described some of the exemplary components of system 100 for content based video organization, prioritization, and retrieval, reference will be made to its operation and the resultant workflows produced from said operation.

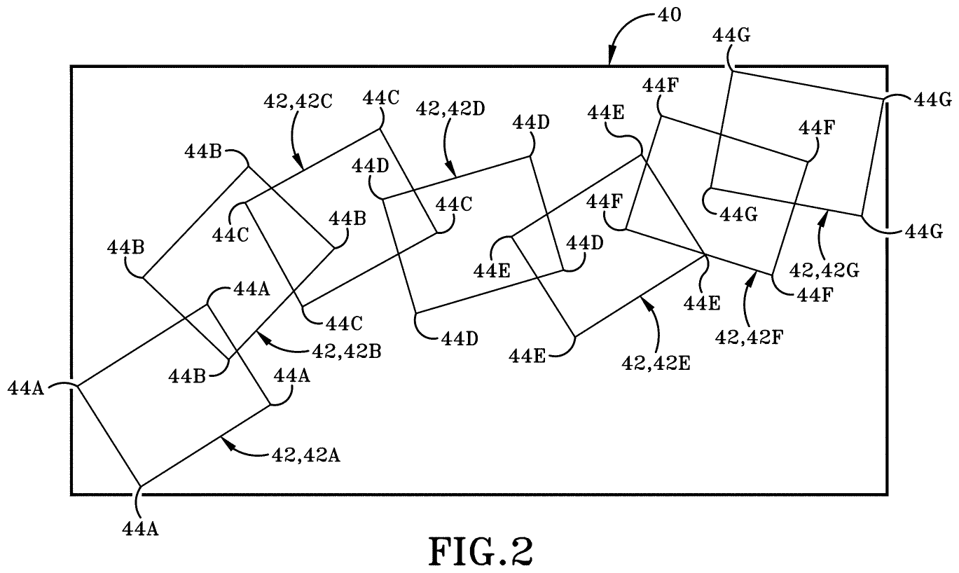

FIG. 2 diagrammatically depicts an overall coverage area 40 obtained by sensor 14. Within the coverage area 40, there is a plurality of individual image frames 42 defined by a “footprint” area. In this particularly diagrammatic example, the plurality of individual image frames 42 includes seven individual image frames, however any number of image frames will suffice. Particularly, there may be a first image frame 42A having a first footprint area bound by corner points 44A, a second image frame 42B having a second footprint area bound by corner points 44B, a third image frame 42C having a third footprint area bound by corner points 44C, a fourth image frame 42D having a fourth footprint area bound by corner points 44D, a fifth image frame 42E having a fifth footprint area bound by corner points 44E, a sixth image frame 42F having a sixth footprint area bound by corner points 44F, and a seventh image frame 42G having a seventh footprint area bound by corner points 44G. While the frames are generally depicted as squares, in a further example other shapes are employed and defined by corner points.

When each of the frames 42 is captured by sensor 14, the data observed by the sensor 14 contains metadata. The metadata include, but are not limited to, the sensor's 14 position in space, the sensor's 14 orientation and sensor 14 parameters such as field of view 29, zoom level, etc., and the corner points 44A-44G in latitude and longitude of the footprint of the area within the field of view 29 of the sensor 14 (i.e., what the sensor can see on the ground). These metadata include parameters which are not recorded directly by the sensor but are derived through additional calculations such as GSD.

In one particular example, a packet of metadata information may be transmitted at selected or predetermined intervals. For example, the metadata packet may be transmitted every sixth frame in the video data stream. However, it is possible for the frames that contain the metadata packet to be every frame, or the frames can have a varying number of intermediate frames that do not contain metadata. For the purpose of the examples contained herein, reference to the term frame indicates the frame or frames in the video stream that contain or has the metadata packet associated with it.

The coordinates of the footprint of the area bound by its corners 44 within the field of view of the sensor are obtained from the metadata directly or can be inferred using the sensor's position and orientation. To obtain the coordinates directly from the metadata, one exemplary system can utilize logic that executes computer instructions to retrieve the coordinates at the corners of the field of view from the frame and indexes or stores the coordinates into a memory. Alternatively, the system exports the coordinates of the corners 44 of one frame 42 of the footprint area of the field of view to an associated processor. In a forensic application, the entire coverage area 40 of the video stream or feed from sensor 14 is processed to determine the minimum and maximum latitude and longitude visible across the coverage area 40 containing all frames 42. In a real time application the bookkeeping and indexing of the area covered expands as the sensor 14 moves with platform 12.

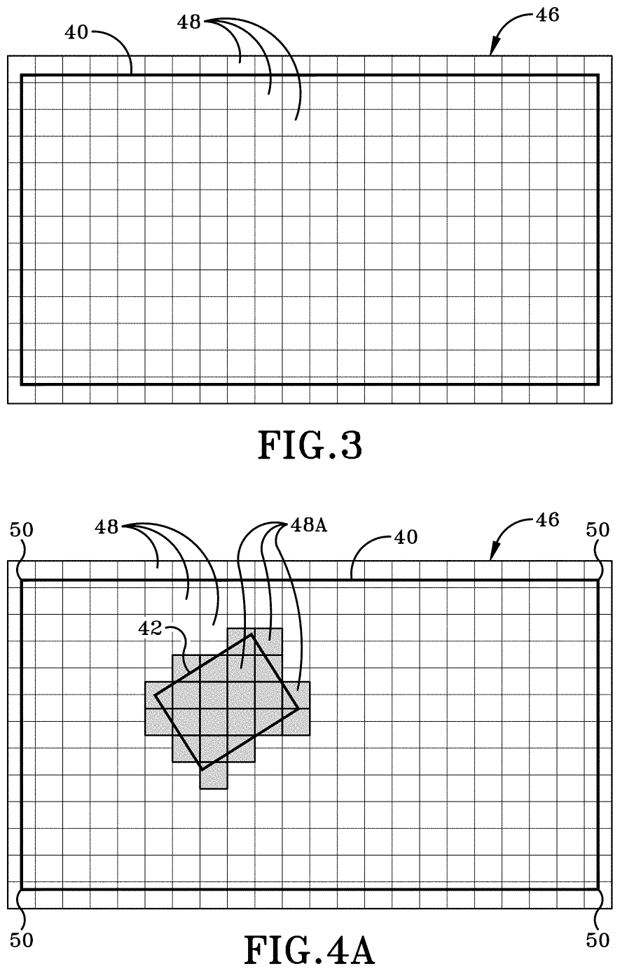

FIG. 3 depicts that the logic of system 100 maps or registers the coverage area 40 to a grid 46 associated with the photo of the landscape 22 being surveilled. The grid 46 may also be referred to a universal grid. The grid 46 can be composed of a plurality of computer-defined bins or tiles 48 (i.e., generally square or rectangular regions) arranged in an array. This universal grid 46 assigns a fixed identification to each bin or tile 48 defined in terms of latitude and longitude spanning or covering the ground 27 surface. In one particular embodiment, there are a sufficient amount of tiles 48 to cover the entire surface of the earth. The tiles 48 being defined by fixed identification values enables a one-to-one mapping so that each latitude-longitude pair has exactly one tile 48 that it covers or is encompassed within. This particular tile 48 establishes a single universal grid bin identifier (Bin ID). In some examples, the universal grid 46 has multiple zoom levels allowing for tiles of different sizes.

The universal grid 46 yields a binary-image-based representation of the overall coverage area 40. Each pixel in the binary image corresponds to a universal grid bin (defined by one tile 48). In one particular embodiment, there may not be a perfect overlap between the edges of overage area 40 and the edges of universal grid bins or tiles 48. In this embodiment, this can be done as a purposeful design choice to permit coarse graining on the target LOI or object without unnecessary computation. However, it is entirely possible to provide a fully perfect overlap of the coverage area over the universal grid bins.

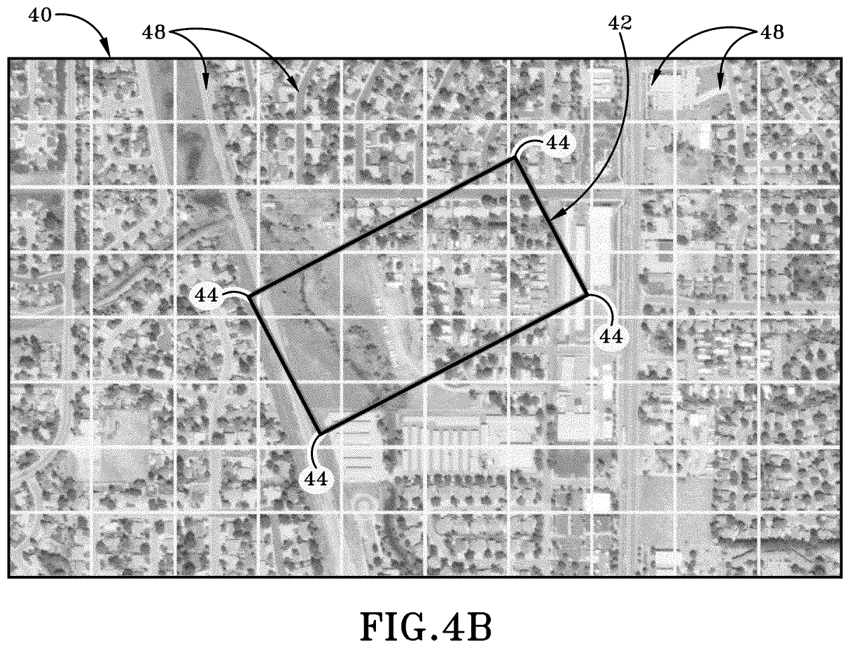

FIG. 4A depicts an example in which the coverage area 40 is spanned by an array of 13×22 universal grid bins or tiles 48. If the video has N frames with metadata packets, the system or logic of the system creates a spatial index in the form a single 13×22 image with N binary channels, where N is any integer. The initial value of each pixel is zero. For the N-th frame, the system maps the sensor's footprint 42 into these universal grid bins or tiles 48.

This procedure is done by first obtaining the universal grid bins or tile 48 for each corner point 50 of the coverage area 40 or field of view. The system creates, registers, represents, or otherwise draws a shape, such as a rectangle, representing the frame 42, in the pixel space of tiles 48 of the coverage image representation. This provides an advantage over testing whether the sensor footprint or frame 42 intersects each individual universal grid bin or tile 48. This process then sets all of the pixels corresponding to bins or tiles 48 visible to the sensor (as defined by the coverage area 40) to a binary value. In one embodiment, the viewable bins or tiles 48 within or overlapped by frame 42 are set to one while the non-viewable bins that are not overlapped by frame 42 are set to zero. However, the reverse is a further embodiment. The viewable bins or tiles 48 may be set to zero and the non-viewable bins set to one. Depending on which binary values are utilized would require a change in mathematical calculations to account for the selected value. In FIG. 4A, the shaded tiles 48A that overlap with frame 42 represent binary values of one, while the unshaded tiles that do not overlap frame 42 represent binary values of zero.

FIG. 4B is a representation with real-word map imagery of that which was described in FIG. 4A. FIG. 4B depicts that the coverage area 40 is divided into bins or tiles 48. As the platform flies, the first frame 42 of metadata is obtained. The first frame 42 of metadata will indicate the sensor 14 is viewing the area on the ground represented by the outline of frame 42. The system will know where the corners of the frame 42 is located in one of the grid cells. The logic of system 100 will then retrieve those cells, bins, or tiles 48 within which the frame 42 is viewing.

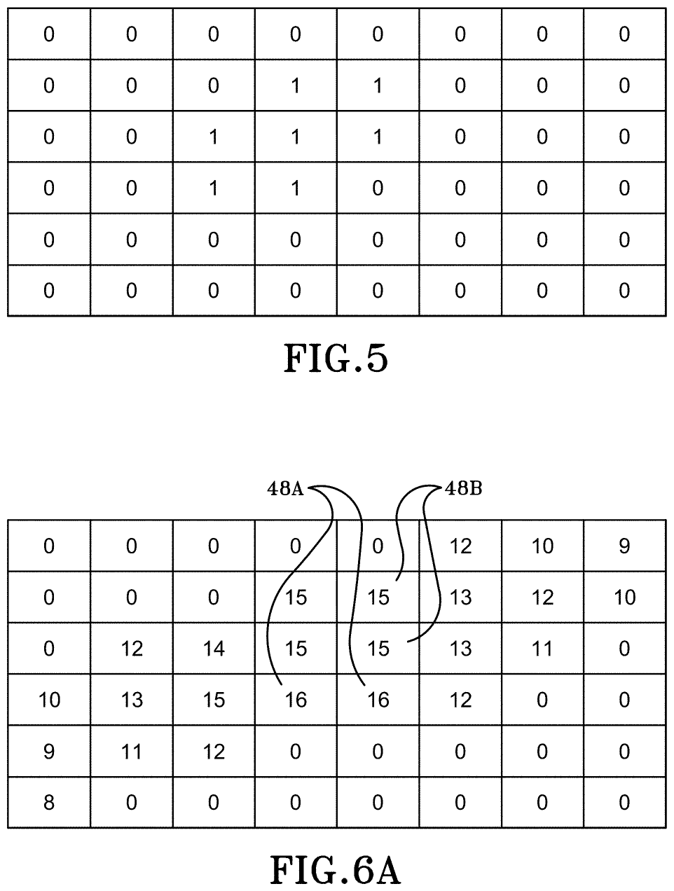

FIG. 5 diagrammatically depicts the exemplary embodiment of spatial indexing for a Bin ID array, where each Bin ID or tile 48 corresponds to one pixel, in which the bins or tiles that are visible to the sensor have been designated with a one and the non-visible bins have been designated with a zero. To determine whether a particular point, having a specific latitude-longitude pair, is visible to the sensor 14 on the N-th frame, the system 100 obtains the Bin ID corresponding to that point. The system 100 determines whether this Bid ID is within the frame 42. If the Bin ID is not within the frame 42, then that bin was not visible. If the Bin ID is within the frame 42, then then that bin was visible. For the visible bins, the system obtains the pixel coordinate including the latitude-longitude pair thereof. The system tests the pixel value of the visible bins in the N-th frame or channel of the binary image. In this instance, the binary value of one means that the bin was visible and the binary value of zero means that the bin was not visible. Then, to obtain the other frames in which a point having a specific latitude-longitude pair is visible, the system repeats this process and tests the pixel value of the visible bins for each channel of the binary image.

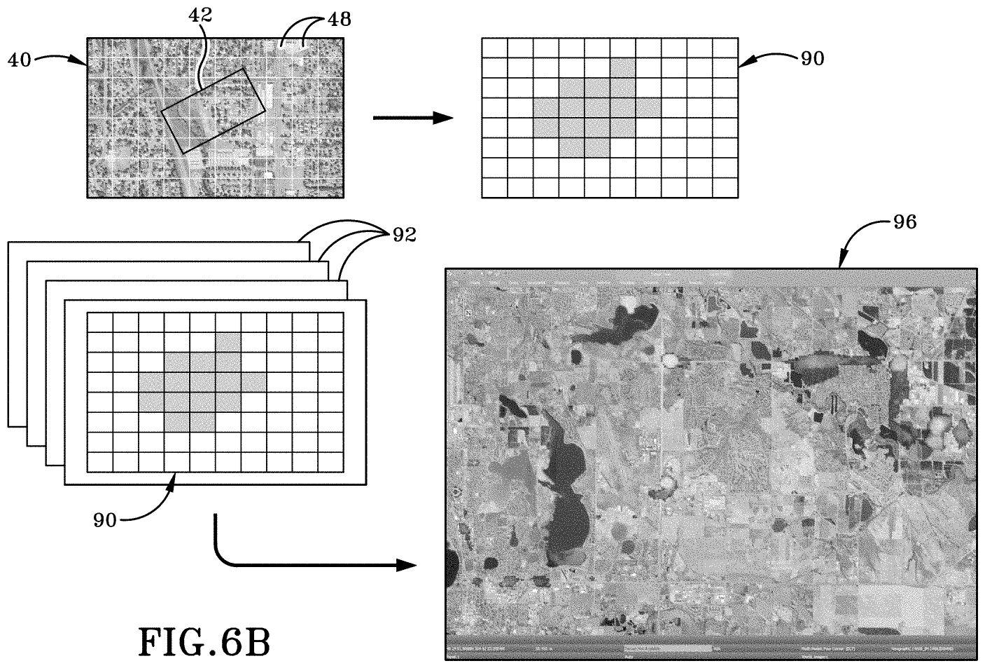

FIG. 6A depicts that the system can obtain the overall coverage statistics for the entire video. This is accomplished by summing the pixel values across all the channels. FIG. 6A diagrammatically depicts the summation of the pixel value across all channels for the entire video. The bins that indicate zero are the non-visible bins. The bins that have a summed value greater than zero are visible. The values that are higher, relative to the other summed values, are indicative of greater times of visibility of a bin relative to the visibility times of other bins having lower summed values. For example, as shown in FIG. 6A, the bins or tiles 48A having a summed values of sixteen were visible the longest. The bins or tiles 48B having a summed value of fifteen were visible the next longest, but slightly less than bins or tiles 48A.

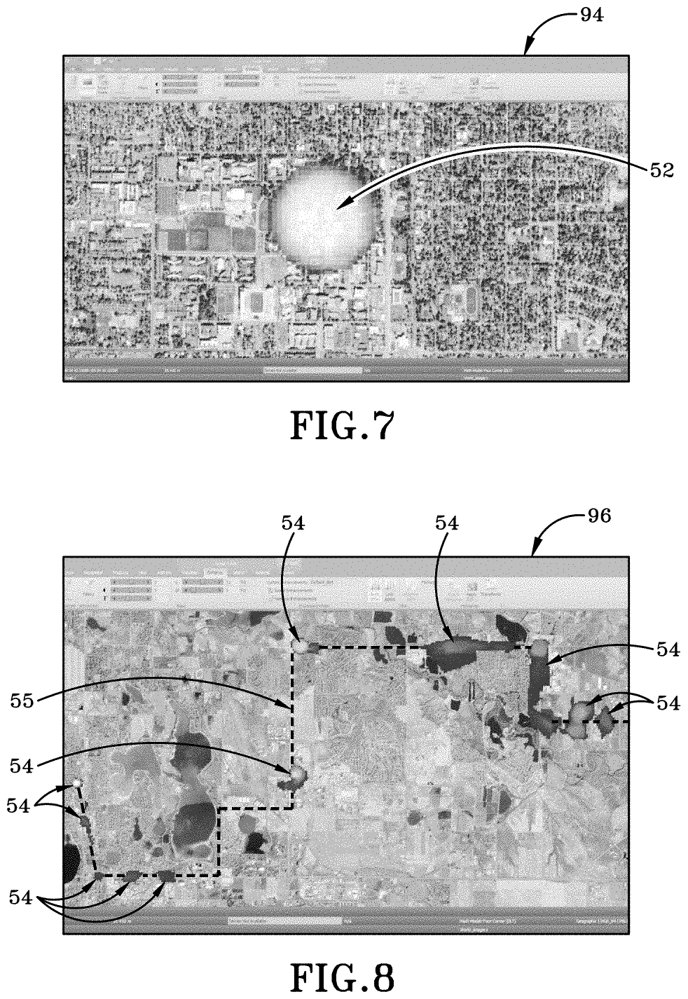

FIG. 6B is a representation with real-word imagery of that which was described in FIG. 6A. The frame 42 overlaps each of the tiles 48 to create a course grid representation 90 of the field of view as that particular frame 42. The coarse grid representation 90 is a pixel image, where one pixel is one grid cell or tile 48. This allows the system of the present disclosure to very efficiently convert a metadata stream into a spatial index. The spatial index is then saved in memory 17. Then, the logic of system 100 can determine whether a LOI or target, such as structure 26, is within the field of view 29 by testing, via binary, whether that one particular pixel is either one or zero. To obtain the total coverage, the system will sum how many marked pixels, i.e. a binary value of one, are at that given LOI. For example, if an object to be detected, such as structure 26, is in one of the pixels, and that pixel is selected by the operator, the logic of system 100 will retrieve from the spatial index all the frames for which that particular pixel has a binary value of one. This indicates that the target LOI was visible in that pixel at a given time. Then, the logic of system 100 will identify the frame numbers or channels 92 for which all the pixel values were one for that particular pixel. This will identify, based on the indexing with the other metadata, the values of the sensor at that given time. For example, when a certain pixel is selected, the frames will be retrieved and the other metadata information, such as azimuth, look angle, occlusions, or the like will be tabulated and filtered so that only the pixels of the video in which that target was visible and how they relate to the overall timeline. Once these data streams are extracted or retrieved, they can be reorganized in an efficient manner such as to create the heat map. The logic of system 100 utilizes the summed pixel values to generate a heat map that overlays a reference image to indicate the regions in which the frames were viewing. Two different exemplary heat maps 94, 96 are shown in FIG. 7 and FIG. 8, respectively.

FIG. 7 depicts an exemplary heat map 94 in which the platform 12 carrying the sensor 14 was flying in a circular formation, and thus the heat map is generally localized over one point that would have the highest summed values near the center 52.

FIG. 8 is a heat map 96 in which the platform carrying the sensor was traveling along a specific flight path 55, as defined by splotches or indicators 54 of the heat map 96 that indicates the visible bins during the flight path 55. Notably, the heat map 96 showing splotches or indicators 54 may include a threshold or filter so that it does not show the non-visible bins. For example, any bin having a summed value of zero or below threshold can be set to not show any heat map representation (i.e., splotches or indicators 54) and only display the underlying reference background image.

In addition to the spatial indexing features and processes described herein, the system 100 may also provide temporal indexing. With respect to temporal indexing, the system may extract, store, and index into a database a set of specific parameters of metadata for each frame at a given time. This temporal indexing enables retrieval of metadata parameters of a frame at a given time. In one example, the metadata parameters that are extracted, stored, and indexed for each frame may include a UNIX time stamp date, a UNIX time stamp, the event start time, UTC date, platform ground speed, platform heading angle, platform pitch angle, platform roll angle, sensor true altitude, sensor latitude, sensor longitude, sensor horizontal field of view, sensor vertical field of view, sensor relative azimuth angle, sensor relative elevation angle, sensor relative roll angle, slant range, target width, frame center latitude, frame center longitude, frame center elevation, coverage area first corner latitude, coverage area first corner longitude, coverage area second corner latitude, coverage area second corner longitude, coverage area third corner latitude, coverage area third corner longitude, coverage area fourth corner latitude, coverage area fourth corner longitude, offset first secondary corner latitude, offset first secondary corner longitude, offset second secondary corner latitude, offset second secondary corner longitude, a sensor model software object with adjusted orientation if any error is observed, frame number, a polygon representation of the sensor footprint, a software object which can retrieve the corresponding frame from the video as an image, ground spatial distance (GSD), a video national imagery interpretability rating scale (VNIIRS) amount, or any objects, people, vehicles detected in the frame by an external object recognition system or tracker.

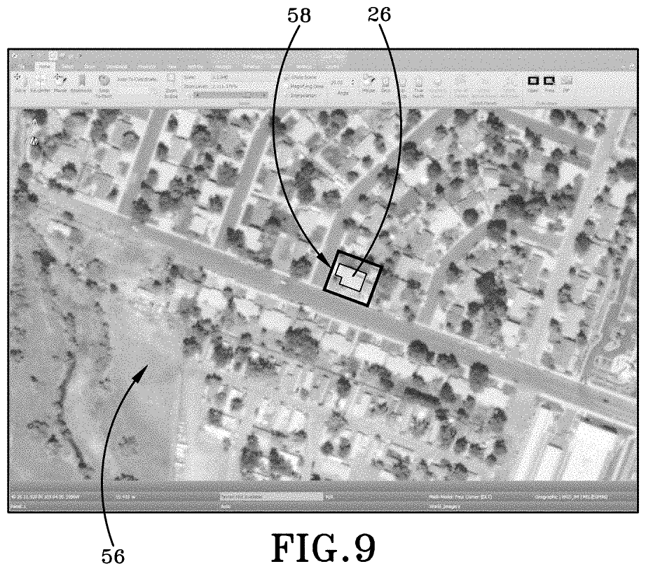

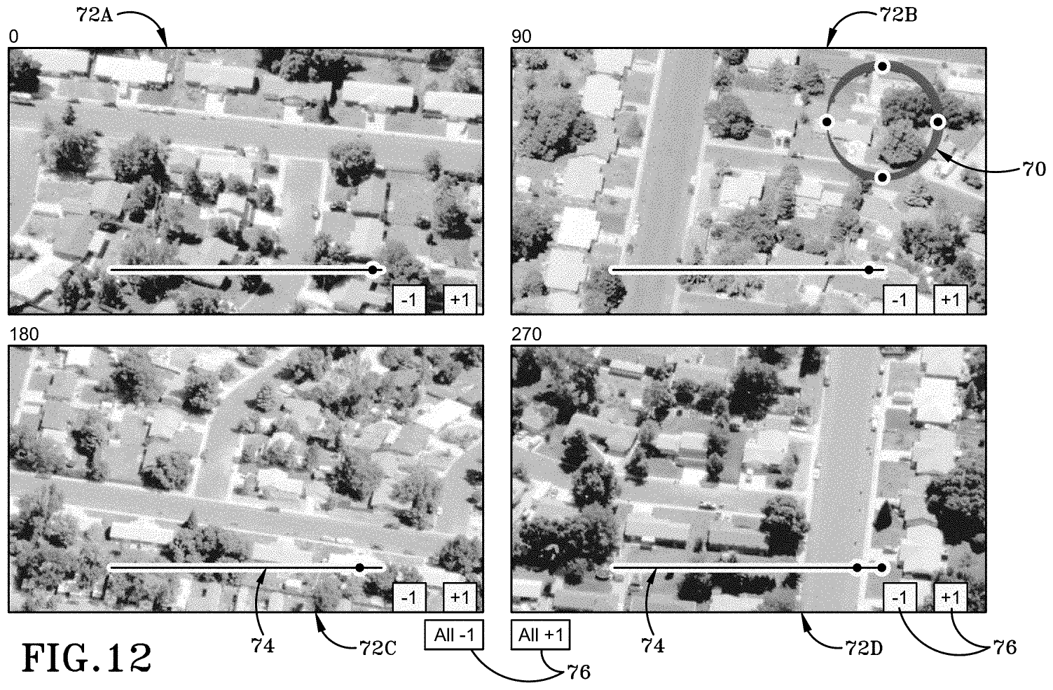

FIG. 9 depicts an example of a user interface for the system of the present disclosure that may integrate with a map-based software. One exemplary map-based software is commercially known as SOCET GXP. The SOCET GXP software may integrate with another video software known as InMotion to provide the cardinal coordinate representation to a user. In operation, computer implemented instructions of system 100 are executed when a user desires to view a target LOI, such as structure 26. The target LOI will be selected on a representative image 56. The selection of the target LOI may be accomplished by selecting or drawing a box 58 around the target LOI containing structure 26. In response to selection of the target LOI, the particular latitude and longitude of the selected target LOI and the orientation angle of the box drawn will be known by system 100. The map shown in FIG. 9 indicates that a user can navigate to a map-based photo and draw a box around a building or structure 26 that has been tasked to obtain four cardinal views and then launch the application of the system of the present disclosure to obtain the four cardinal views shown in FIG. 12, described below.

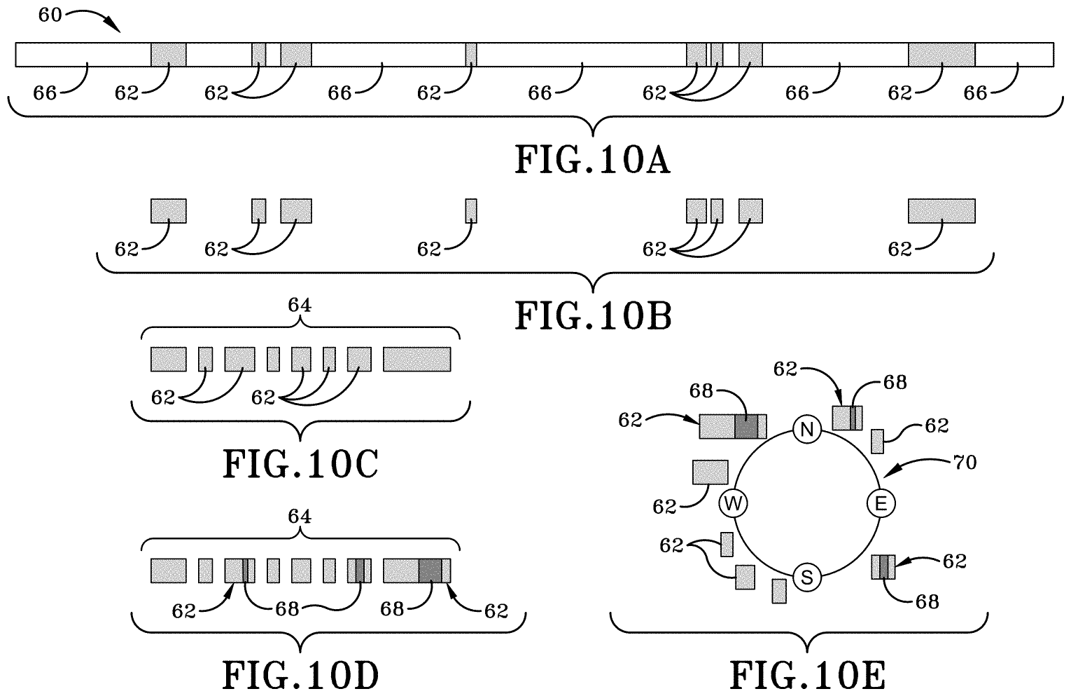

Once the target LOI is selected, the system can then use the spatial index to determine which frames to show at the point of the target LOI as described in greater detail herein. The determination of which frames to show will be accomplished by retrieving the stored metadata parameters for a given frame that depicts the target LOI as described herein with reference to FIG. 10A-FIG. 10E. The logic of system 100 may reorganize the retrieve metadata format as described herein with reference to FIG. 10A-FIG. 10E. The reorganization may be based on priority according to a selected criteria. For example, prioritization may be provided to the sensor azimuth and the metadata would be reorganized by giving priority to the frames that have the desired sensor azimuth. The system may then return the reorganized frame order for display to the user. Additionally, the system may provide individual frame images, data summarization of important parameters (GSD, etc.).

FIG. 10A diagrammatically depicts an exemplary timeline 60 that would be present in a video software application integrated with computer implemented programming, instructions, or logic of system 100. The shaded regions 62 represent sequences of image frames 42 along the timeline 60 in which an object of interest or target (such as structure 26) was seen through the field of view 29 of the image sensor 14.

FIG. 10B diagrammatically depicts that the logic of system 100 of the present disclosure provides the ability for the shaded regions 62 to be pulled out and extracted from the timeline 60. FIG. 10C diagrammatically depicts that these shaded regions 62 are then condensed into an optimized data set 64 of frames 42 so that the logic of system 100 or an operator thereof can more efficiently toggle through image frames 42 that are of interest (because they include the target or object of interest, such as structure 26) and disregard image frames that are not of interest. The frames that are not of interest are represented by regions 66 in FIG. 10A.

FIG. 10D diagrammatically depicts that the condensed data set 64 can be further optimized. The logic of system 100 can highlight or otherwise identify which of these shaded regions 62 has the best or optimized video qualities. In this example, the best GSD (ground spatial distance) is identified as regions 68 within the shaded regions 62. However, prioritizing according to other optimized metadata parameters, such as those described herein with respect to temporal indexing, is possible.

FIG. 10E depicts that once the optimized regions 68 of information or frames are determined, they may be placed onto a cardinal coordinate representation 70 so that a user can quickly evaluate the target from various perspectives. The cardinal coordinate representation 70 or direction plot (having representations for north, south, east, and west) reorganizes the time slices 62 of image frames 42 depicting the target or structure 26. Portions around the circle representing the cardinal directions are time agnostic. Rather than being sequentially oriented, the data is placed relative to the cardinal direction representation 70 or circle so that a user may rapidly evaluate the target or structure 26 from a perspective direction of sensor 14 based on frame metadata regardless of the time when the image frame was obtained by sensor 14. In one particular embodiment, as the platform 12 or UAV maneuvers above a landscape, the system 100 will obtain metadata from the image sensor 14. For example, metadata associated with the sensor 14 location from the global positioning system (GPS), inertial measurement unit (IMU), or inertial navigation system (INS) on the platform 12, which are in operative communication with the image sensor, reregisters spatial and temporal information of objects, such as structure 26, within the field of view 29 of the sensor 14.

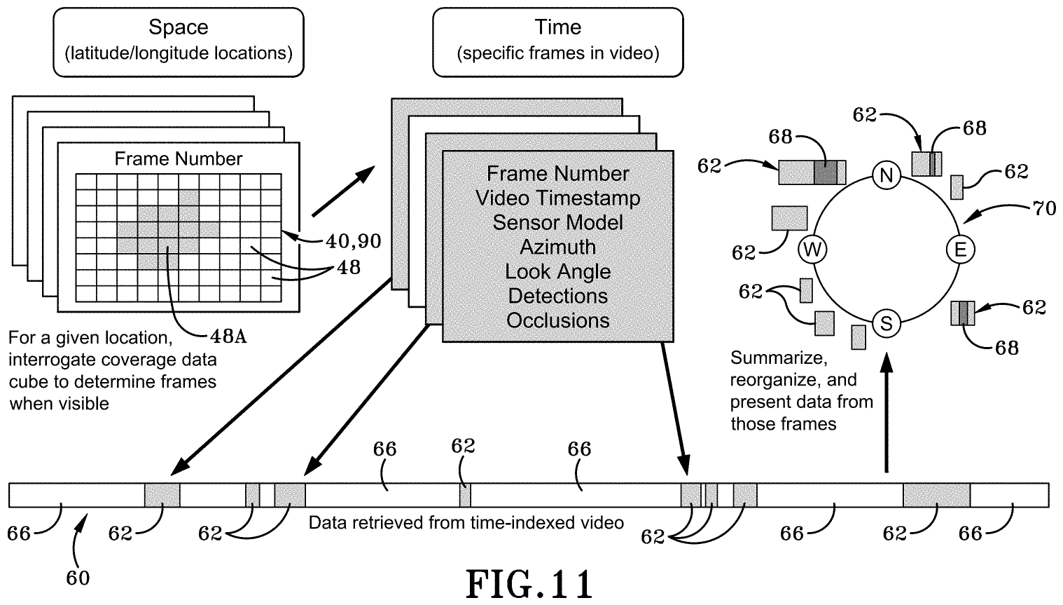

FIG. 11 depicts that in order to accomplish the reorganization of the data around the cardinal representation 70, the logic of system 100 will evaluate a significant portion or the entire video and obtain the maximum latitude, maximum longitude, minimum longitude, and minimum latitude. These maximum and minimum latitudes and longitudes bound the overall coverage area 40. After the bounded region or coverage area 40 has been created, the logic of system 100 creates bins or tiles 48 to represent at multiple zoom levels. The position of one particular tile 48 is a math formula represented by the latitude and longitude thereof. Therefore, the logic of system 100 is able to obtain the same tile regardless of from where the tile was obtained.

The system then breaks the field of view into the set of tiles 48 that can be utilized and labeled. In one particular example, each tile 48 may be approximately 13 meters by 13 meters. Each of these tiles may be labeled. In each instance in which a frame has metadata, and when the metadata updates, the logic of system 100 determines which tiles 48 are in the field of view of the sensor. Then, the logic of system 100 updates the indexing by placing a timestamp for whenever the object was in the frame in those boxes as described with reference to FIG. 5. The logic of system 100 then loops over the entire video and tracks the instances in which the object was in a frame and sums those instance as described with reference to FIG. 6A and FIG. 6B. That bin or tile 48 will identify the timestamp. The metadata will reveal the location of the sensor 14 at that particular time along with the cardinal direction in which the sensor 14 was looking. The metadata are then extracted and maintained in either a time-based index or a space-based index. Once this is completed, the index can be utilized to obtain all of the necessary views of a target LOI as described below with respect to FIG. 12. For example, if multiple views for a building or structure 26 needs to be determined or obtained, and the logic of system 100 can identify where the building is located and the index will retrieve the corresponding data as to where that grid cell is located, then the system will know the times and retrieve the same. For each of those times, the system can then retrieve the perimeters and reorganize them based on the desired manner in which the data is to be displayed.

FIG. 12 depicts an exemplary resultant image or workflow product that was automatically created by system 100 having four cardinal direction views of structure 26 in a format or representation to enable the user to toggle or select views of a desired target LOI based on north, south, east, and west azimuth angles. The cardinal coordinate representation 70 may also include representations of video quality based on the thickness of the circle. For example, when more views are obtained from a specific direction, the circle may be thicker than in other regions where less views were obtained. Alternatively, the circle thickness can indicate a different parameter, such as showing thicker regions with the best GSD and thinner regions where the GSD is not as good. Additionally, each image panel (west panel 72A, south panel 72B, east panel 72D, north panel 72D) may have a custom timeline 74 showing when the azimuth was available and may include fine-tune buttons 76 or inputs to allow a user to selectively choose to alter a view relative to a specific image frame.

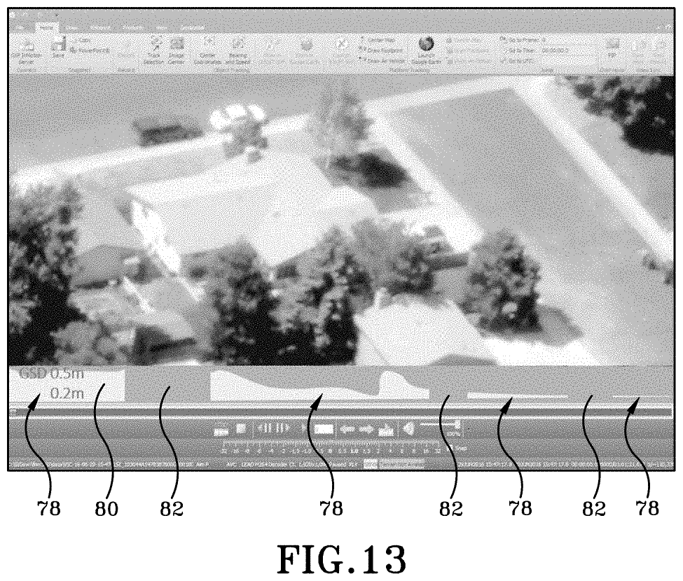

FIG. 13 is an example of a data summarization workflow product. FIG. 13 depicts that the logic of system 100 of the present disclosure may also provide a graph or representation 78 indicating a timeline data summarization of when the target LOI was present or not present in a video stream. The universal grid bin corresponding to this location of structure 26 is retrieved, along with all the frames for which it is visible. Then, a metadata parameter, like GSD (the user can select one from a drop down menu), is computed for each of those frames, and the results are plotted along the video timeline graph that represents the GSD at a particular time. As such, thicker regions 80 of the graph 78 represent times at which the GSD was higher, whereas thinner portions of the graph represent times at which the GSD is lower. When there is a gap or space 82 in the graph 78, that is representative of a time at which the target LOI or structure 26 was not shown in the video stream.

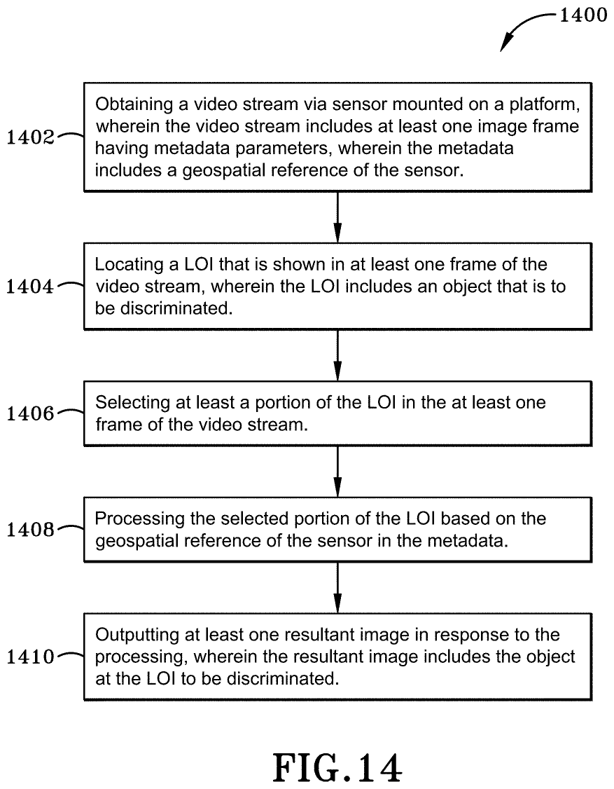

FIG. 14 is a flowchart depicting an exemplary method of the present disclosure according to the techniques and features described herein. The method is shown generally at 1400. Method 1400 includes obtaining a video stream via sensor 14 mounted on platform 12, wherein the video stream includes at least one image frame having metadata parameters, wherein the metadata includes a geospatial reference of the sensor 14, which is shown generally at 1402. Method 1400 includes locating a LOI that is shown in at least one frame of the video stream, wherein the LOI includes an object, such as structure 26, that is to be discriminated, which is shown generally at 1404. Method 1400 includes selecting at least a portion of the LOI in the at least one frame of the video stream, which is shown generally at 1406. Method 1400 includes processing the selected portion of the LOI based on the geospatial reference of the sensor in the metadata according to the techniques described herein, which is shown generally at 1408. Method 1400 includes outputting, automatically, at least one resultant image, such as the workflow images 72A-72B or the image and graph shown in FIG. 13, in response to the processing, wherein the resultant image includes the object at the LOI to be discriminated, which is shown generally at 1410.

As described herein, aspects of the present disclosure may include one or more electrical or other similar secondary components and/or systems therein. The present disclosure is therefore contemplated and will be understood to include any necessary operational components thereof. For example, electrical components will be understood to include any suitable and necessary wiring, fuses, or the like for normal operation thereof. It will be further understood that any connections between various components not explicitly described herein may be made through any suitable means including mechanical fasteners, or more permanent attachment means, such as welding, soldering or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method comprising:
obtaining a video stream via a sensor mounted on a platform, wherein the video stream includes at least one of (i) at least one image frame having metadata parameters and (ii) video stream frames from which metadata parameters are inferred; wherein the metadata parameters includes a geospatial reference of the sensor;
locating a location of interest (LOI) shown in at least one frame of the video stream or in the at least one image frame, wherein the LOI includes an object that is to be discriminated;
selecting at least a portion of the at least one frame of the video stream containing the LOI;
processing the selected portion of the at least one frame containing the LOI based on the geospatial reference of the sensor; and
outputting, automatically, at least one resultant image in response to the processing, wherein the resultant image includes the object at the LOI to be discriminated.

2. The method of claim 1, wherein processing the selected portion of the at least one frame containing the LOI based on the geospatial reference comprises:
grouping a plurality of image frames together that depict the LOI regardless of a time at which the image frames in the plurality of image frames were obtained.

3. The method of claim 2, further comprising:
determining which image frames containing the LOI from the plurality of image frames that are grouped together has a selected level of the metadata parameters.

4. The method of claim 3, further comprising:
filtering the plurality of image frames that are grouped together to retain only the image frames that include the metadata parameters.

5. The method of claim 2, further comprising:
bridging together non-sequential image frames from the plurality of image frames, wherein the non-sequential image frames each depict the LOI at different times as a condensed video stream

6. The method of claim 1, wherein processing the selected portion of the at least one frame containing the LOI based on the geospatial reference in the metadata parameters comprises:
extracting a first plurality of image frames that depict the LOI from the video stream;
filtering out a second plurality of image frames to retain only the image frames that depict the LOI from the video stream; and
condensing the plurality of image frames that depict the LOI that were extracted to create a condensed video stream of image frames that depict the LOI.

7. The method of claim 6, further comprising:
determining which image frames from the condensed video stream depicting the LOI has a selected level of the metadata parameters; and
identifying the images frames that have the selected level of the metadata parameters.

8. The method of claim 1, wherein processing the selected portion of the at least one frame containing the LOI based on the geospatial reference in the metadata parameters comprises:
parsing the metadata parameters based on the geo spatial reference of the sensor.

9. The method of claim 1, further comprising:
generating a cardinal coordinate representation associated with the at least one resultant image, wherein portions of the cardinal coordinate representation is adapted to be selected to change a view angle of the LOI in the at least one resultant image.

10. The method of claim 9, further comprising:
toggling the view angle in the at least one resultant image in response to selection of a portion of the cardinal coordinate representation.

11. The method of claim 9, further comprising:
generating the cardinal coordinate representation with a circular profile having thicker portions and thinner portions of the circular profile.

12. The method of claim 11, wherein the thicker portions of the circular profile are associated with image frames having higher values of the metadata parameters; and wherein the thinner portions of the circular profile are associated with image frames having lower values of the metadata parameters.

13. The method of claim 12, wherein one of the metadata parameters is ground spatial distance.

14. The method of claim 1, further comprising:
generating a heat map in response to processing the selected portion of the at least one frame containing the LOI based on the geospatial reference of the sensor in the metadata parameters.

15. The method of claim 1, further comprising:
generating a graph in response to processing the selected portion of the at least one frame containing the LOI based on the geospatial reference of the sensor in the metadata parameters; wherein the graph comprises thicker portions and thinner portions of the graph.

16. The method of claim 15, wherein thicker portions of the graph are associated with image frames having higher values of the metadata parameters; and wherein thinner portions of the circular profile are associated with image frames having lower values of a parameter of the metadata parameters.

17. The method of claim 16, wherein one of the metadata parameters is ground spatial distance.

18. The method of claim 15, wherein the graph includes spaces or gaps between portions of the graph, wherein the spaces or gaps represent image frames in which the LOI was not visible.

19. A computer program product including at least one non-transitory computer readable storage medium having instructions encoded thereon that, when executed by one or more processors, implement a process to organize, prioritize, and retrieve images frames based on metadata included with the image frames, the process comprising:
obtaining a video stream via at least one sensor mounted on a platform, wherein the video stream includes at least one image frame having metadata parameters, wherein one of the metadata parameters is a geospatial reference;
locating a location of interest (LOI) shown in at least one frame of the video stream, wherein the LOI includes an object that is to be discriminated;
selecting at least a portion of at least one frame containing the LOI in the video stream;
processing the selected portion of the at least one frame containing the LOI based on the geospatial reference; and
automatically outputting at least one resultant image in response to the processing, wherein the resultant image includes the object at the LOI to be discriminated.
